(19) United States
(12) Patent Application Publication
(10) Pub. No.: US 2008/0156280 A1
(43) Pub. Date: Jul. 3, 2008

(54) Animal control device

(76) Inventor: Terri Kim McNeill, Merritt Island, FL (US)

Correspondence Address: William H. McNeill, P.O. Box 321221, Cocoa Beach, FL, 32032, US

(21) Appl. No.: 11/646,866

(22) Filed: Dec. 28, 2006

(51) Int. Cl. A01K 27/00

(52) U.S. Cl. 119/795

(57) ABSTRACT

An animal control device (30) has a leash (32) with a proximal end (34) and a distal end (36). The distal end (36) is formed to engage an animal harness and can include a spring lock (38) or other suitable engaging feature and the proximal end (34) is fixed to an intimate body-wrap portion (40). The intimate body-wrap portion (40) is maintained in position, once applied, without further attention by the animal handler.

### TECHNICAL FIELD

This invention relates to animal control devices and more particularly to such devices designed to prevent inadvertent bolting by the controlled animal.

### BACKGROUND ART

The standard means of control for animals such as dogs employs a leash comprising a length of cord or similar material having a proximal end and a distal end. The distal end is provided with means, such as, for example, a spring hook for attachment to a collar or harness on the animal, and a loop or other handheld means on the proximal end for gripping by the animal handler. Such a prior art constraint is shown in FIG. 5 wherein a leash 10 has a distal portion 12 with a hook 14, a central body portion 16 and a proximal portion 18 comprised of a loop 20. While such a handheld means works well for the most part, constant attention is required to prevent the animal from bolting while the handler is momentarily distracted, since it is relatively easy for the enlarged loop 20 to be pulled from the grasp of the handler. This can be very dangerous for the animal, particularly if the animal is being walked or exercised in a city or other area where the volume of vehicle traffic is high.

### DISCLOSURE OF INVENTION

It is, therefore, an object of the invention to obviate the disadvantages of the prior art.

It is another object of the invention to enhance animal handling.

It is yet another object of the invention to provide secure attachment for a leash.

These objects are accomplished, in one aspect of the invention, by an animal control device comprising: a leash having a proximal end and a distal end, said distal end being formed to engage an animal harness; and said proximal end being fixed to an intimate body-wrap portion. By an intimate body-wrap portion is meant a closure device that is associated with the person of an animal handler and is maintained in position, once applied, without any further action by the animal handler. Thus, the animal is properly restrained even if the handler is distracted or the animal bolts on its own, since the handler does not have to physically maintain a grip on the distal end of a leash.

### BRIEF DESCRIPTION OF THE DRAWINGS

FIG. 1 is a perspective view of an embodiment of the invention;

FIG. 2 is a perspective view of an alternate embodiment of the invention;

FIG. 3 is perspective view of another embodiment of the invention;

FIG. 4 is a perspective view of yet another embodiment of the invention; and

FIG. 5 is a perspective of a prior art form of animal control device.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

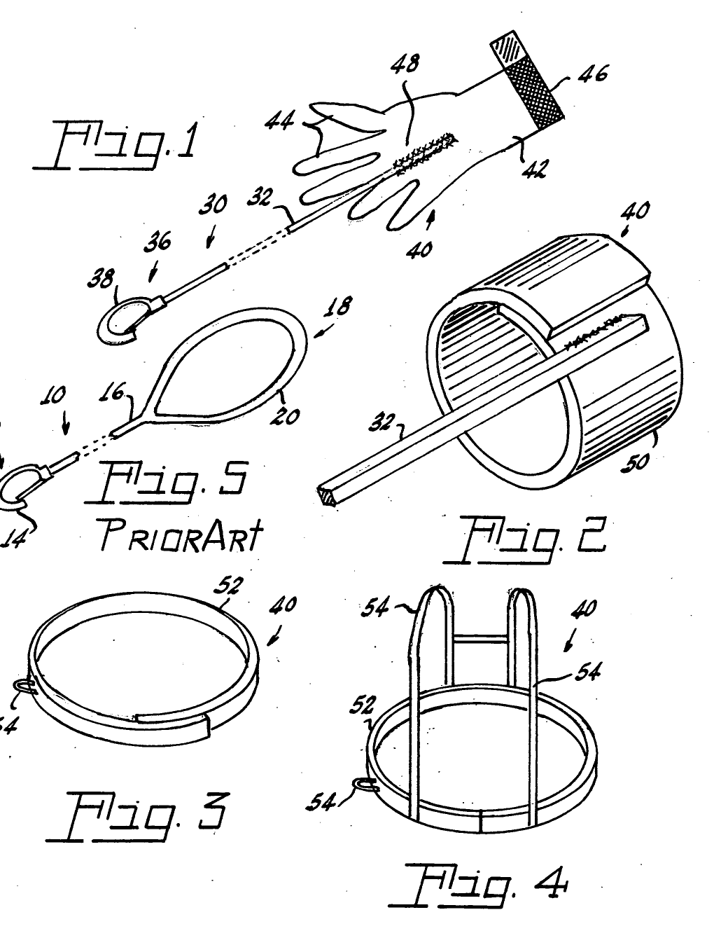

Referring now to the drawings with greater particularity, there is shown in FIG. 1 an animal control device 30 comprising a leash 32 having a proximal end 34 and a distal end 36. The distal end 36 is formed to engage an animal harness (not shown) and can include a spring lock 38 or other suitable engaging feature; and the proximal end 34 is fixed to an intimate body-wrap portion 40. In the embodiment of FIG. 1 the intimate body-wrap portion 40 comprises a glove 42 that in a preferred embodiment can be an ambidextrous glove including digit receptors 44, a wrist engager 46 and a palm area 48 connecting the digit receptors 44 and the wrist engager 46. The proximal end 34 of the leash 32 is permanently fixed to the palm area 48, for example, by sewing. Alternatively, the leash 32 can be an integral part of the palm area 48. The wrist engager 46 can be button fastened or snap fastened. Preferably, the wrist engager includes hook and loop fastening.

An alternate form of the invention is shown in FIG. 2 wherein the intimate body-wrap portion 40 comprises only a wrist-encircling member 50 and the proximal end 34 is fixed to the wrist-encircling member. The preferred form of closure for wrist-encircling member 50 is also hook and loop.

Yet another embodiment of the invention is shown in FIG. 3 wherein the intimate body-wrap portion 40 comprises a waist-encircling belt 52 provided with a fixed loop 54. In this instance, the leash 32 could have both distal and proximal ends provided with spring locks 38.

Yet another embodiment of the invention is shown in FIG. 4 wherein the intimate body-wrap portion 40 includes at least one shoulder strap 54 attached to a waist-encircling belt 52 and the proximal end 34 is fixed to the waist-encircling belt 52, for example, in the manner shown with regard to the embodiment of FIG. 3.

There is thus provided an animal control device that maintains the desired control even in the absence of attention by the animal handler. The device is simple to use and maintain and with the embodiments of FIGS. 3 and 4 in particular, can be easily employed by handicapped individuals having limited arm, wrist or hand control.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. An animal control device comprising:
a leash having a proximal end and a distal end, said distal end being formed to engage an animal harness; and
said proximal end being fixed to an intimate body-wrap portion.

2. The animal control device of claim 1 wherein said intimate body-wrap portion comprises:
an ambidextrous glove including digit receptors, a wrist engager and a palm area connecting said digit receptors and said wrist engager and said proximal end is fixed to said palm area.

3. The animal control device of claim 1 wherein said intimate body-wrap portion comprises a wrist encircling member and said proximal end is fixed to said wrist encircling member.

4. The animal control device of claim 3 wherein said wrist encircling member includes a hook-and-loop closure.

5. The animal control device of claim 1 wherein said intimate body-wrap portion comprises a waist-encircling belt having a fixed loop extending therefrom.

6. The animal control device of claim 1 wherein said intimate body-wrap portion includes at least one shoulder strap and a waist encircling portion and said proximal end is fixed to said waist encircling portion.
